(19) United States
(12) Patent Application Publication
(10) Pub. No.: US 2012/0084309 A1
(43) Pub. Date: Apr. 5, 2012

(54) SYSTEM AND METHOD FOR MATCHING COUPLES WITH EVENTS

(75) Inventors: Robert SCHUMANN, Oakton, VA (US); Laurence ROTH, Vienna, VA (US); Richard WHITTEMORE, Herndon, VA (US); Mary SCHUMANN, Oakton, VA (US)

(73) Assignee: TDNC Corp., Oakton, VA (US)

(21) Appl. No.: 13/252,903

(22) Filed: Oct. 4, 2011

Related U.S. Application Data
(60) Provisional application No. 61/389,648, filed on Oct. 4, 2010.

(51) Int. Cl. G06F 17/30

(52) U.S. Cl. 707/758; 707/E17.014

(57) ABSTRACT

Methods and systems are disclosed that identify date elements for a client, determine whether the identified date elements are excluded based on client profile information, determine whether the identified date elements are excluded based on respective profile information of two or more of the members of the client, and provide to the client one or more of the identified date elements that are consistent with the client profile information or the profile information of the two or more of the members.

### FIELD

The disclosed embodiments relate to matching groups of individuals with events.

### BACKGROUND

Matchmaking systems have been created to introduce unattached individuals (i.e., singles) to one another. These systems may employ sophisticated algorithms to evaluate compatibility between individuals. After being established, couples may use a variety of information sources to help them determine what to do for entertainment. This information includes personal experience, recommendations from friends, reviews and advertisements.

Despite the quantity of information available, couples routinely choose activities that are familiar, easy and available at the last minute. Often, these choices are due to a lack of time to investigate and schedule the activities.

### SUMMARY

The present disclosure is directed to matching specific date elements to client profiles. Example embodiments are operable to identify date elements for a client, determine whether the identified date elements are excluded based on client profile information, determine whether the identified date elements are excluded based on respective profile information of two or more of the members of the client, and provide to the client one or more of the identified date elements that are consistent with the client profile information or the profile information of the two or more of the members.

It is to be understood that both the foregoing general description and the following detailed description are exemplary and explanatory only, and are not restrictive of the claimed subject matter.

### BRIEF DESCRIPTION OF THE DRAWINGS

FIG. 1 is a block diagram illustrating an exemplary system environment;

FIG. 2 is a process flow chart illustrating exemplary steps performed by the system in inferring client preferences;

FIG. 3 is a process flow chart illustrating exemplary steps performed by the system in matching dates with clients;

FIG. 4 is a process flow chart illustrating exemplary steps performed by the system in selecting dates for clients;

FIG. 5 is a process flow chart illustrating exemplary steps performed by the system in processing date feedback from clients; and

FIGS. 6A-6S illustrate example embodiments.

### DETAILED DESCRIPTION

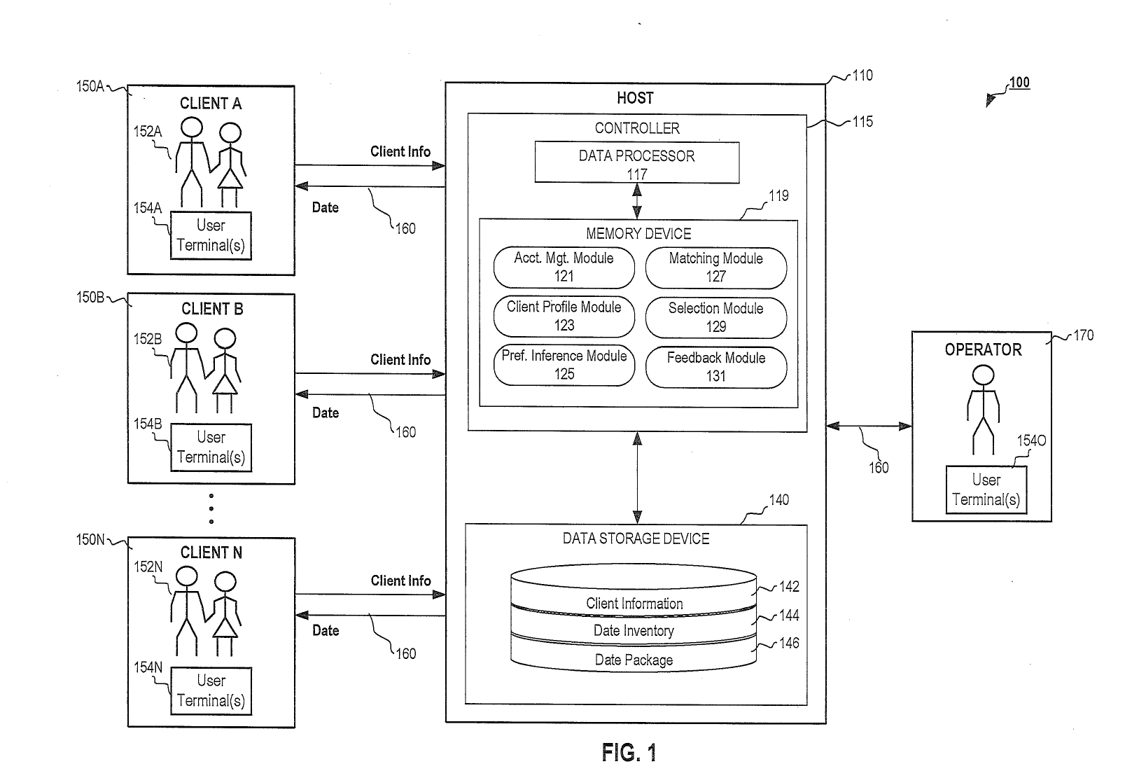

FIG. 1 is a block diagram illustrating an exemplary environment in which the methods and systems of the present disclosure may be implemented. The environment includes a host system 110 (“host”), client groups 150 (collectively, “clients”) and an operator 170 communicatively linked by communication channels 160.

The host 110 may be a system operated by a service that arranges “dates” for the clients 150. Dates are collections of one or more date elements including activities, goods and/or services. In the example embodiments disclosed herein, the dates are social or entertainment activities, such as shows, sporting events, cultural events, festivals, parties, meals, meetings, trips or the like. However, the dates are not limited to such events and may relate to business, educational, religious, political or community service activities instead.

The client 150 is a group of individuals that receives dates from the host 110. In the example embodiments, the clients 150 are described as couples (i.e., individuals that are pair-bonded). However, the meaning of “client” is not limited to couples and may be any group of two or more individuals, including families, friends, clubs, teams, business groups and the like. While a client 150 may be the beneficiary of the operator's 170 service, it is not necessary that the client 150 be the same entity that initiates or maintains the client's 150 membership in the service. For instance, a client 150's membership can be paid for by a family member as a gift or be provided by a business entity as a perk.

As illustrated in FIG. 1, the host 110 may provide dates based on information received from the clients 150. The clients 150 may exchange information with the host 110 over the communication channels 160 via one or more user terminals 150. A user terminal 150 may be a personal computer, a television set-top box, a video game console, a smart phone, a personal digital assistant, a telephone or a mobile phone. Although FIG. 1 illustrates the members of some of the clients 150 (i.e., “client-members”) sharing a single user terminal 150, the client-members 152 may, of course, use separate terminals, which may be at different locations. Alternatively or additionally, the clients 150 may communicate with the service via telephones (e.g. using an operator or interactive voice response system) or hand-carried delivery services (e.g., a postal service).

Communication channels 160 are physical means of communicating information between the host 110, the clients 150 and/or the operator 170. Where the information is transferred electronically, the communication channels 160 may be a wired or wireless link that uses a variety of communication protocols. In some embodiments, the communication channel 160 can be a direct connection, such as an analog, a serial or a parallel interface. In other embodiments, the communication channel 160 may be a shared, public, private, or peer-to-peer network, encompassing any wide or local area network, such as an extranet, an intranet, the Internet, a Local Area Network (LAN), a Wide Area Network (WAN), a virtual private network (VPN), a voice over internet packet network (VoIP), a public switched telephone network (PSTN), an Integrated Services Digital Network (ISDN), or any other form of wired or wireless communication. Further, the communication channel 160 can be compatible with any type of communications protocol used by the components of the system environment to exchange data, such as the Ethernet protocol, ATM protocol, Transmission Control/Internet Protocol (TCP/IP), Hypertext Transfer Protocol (HTTP), Hypertext Transfer Protocol Secure (HTTPS), or peer-to-peer protocol. As noted above, the clients 150 may also communicate with the operator 170 and/or the host 110 via other communication channels 160 such as telephone networks and mail, for example.

The host 110 can be one or more devices residing at one or more locations for receiving, storing, and/or processing client information, and for providing dates to the clients 150. The host 110 can be implemented as one or more information processing systems including, for example, a personal computer, a minicomputer, a microprocessor, a workstation, a server, a mainframe or a combination thereof. As illustrated in FIG. 1, the host 110 may include a controller 115 and a data storage device 140. In addition, the controller 115 may include other elements, such as a clock, a communication interface, a data bus, an input/output device, a user-input device and a display device (not shown).

The processor 117 may be a general-purpose processor (e.g., INTEL or IBM), or a specialized, embedded processor 117 (e.g., ARM). Memory device 119 may be a random access memory (“RAM”), a read-only memory (“ROM”), a FLASH memory, or the like. Although the memory device 119 is depicted as a single medium, the device may comprise additional storage media devices.

The controller 115 may execute programs stored in memory device 119 (or the data storage device 140) that control the host 110 to function as a special-purpose machine that performs the functions described below. As shown in FIG. 1, the programs may include, an account management module 121, a client profile module 123, a preference inference module 125, a matching module 127, a selection module 129 and feedback module 131. Additionally, although not shown, the memory device 119 may include other computer-executable instructions such as an operating system, control modules, hardware drivers, codecs, user interfaces, applications, network servers, network browsers, etc.

The account management module 121 includes program instructions that control the host 110 to create client accounts and manage records related to the client accounts. An account record is maintained for each client 150 that is a member of the service provided by the host 110. An account record may include login information, subscription information, payment information and profile information.

The client profile module 123 includes program instructions that control the host 110 to receive client information and store the information in one or more records that comprise a client profile. The client profile information may include demographic information, ability information and preference information.

The preference inference module 125 includes program instructions that cause the host 110 to determine client-member preferences based on the client information (e.g., demographic information, ability information and preference information) and feedback (e.g., date selections and date feedback) received from clients 150 and/or individual client-members 152.

Additionally, the preference inference module 125 may incorporate links to external information sources to determine preferences or data, which could be used to receive additional preference information. Examples of external data sources are credit card transaction histories, merchant activity history such as NETFLIX, AMAZON, ITUNES, etc, travel history such as from TRAVELOCITY or TRIP ADVISOR, reservation data from OPEN TABLE and recommendations and information from social networking sites such as YELP, FACEBOOK, as well as address demographic data, etc. This data may be acquired with or without direct information from the user to access the data. For example, demographic data based on an address could be acquired directly, while a user's FACEBOOK data might require the user to enter their FACEBOOK login information in order for the system to directly access the data. In some embodiments, the preference inference module 125 may use the data sources above to predetermine client-member preferences before the host 110 receives explicit preference from a client-member 152. In other words, the host 110 may “pre-load” preferences into the client-member's profile.

The matching module 127 includes program instructions that control the host 110 to determine what date elements to offer a particular client 150 based on the client's 150 profile information. The matching module 127 may also detect conflicts between the client profile information (demographics, abilities and preferences) and potential date elements.

The selection module 129 includes program instructions that cause the host 110 to provide or assign a selection of one or more date elements to the client 150. In some embodiments, the host 110 may assign a date element to the client 150. In other embodiments, the client 150 may interactively select date elements provided by the host 110 (e.g., via a user interface provided at the user terminal 150) to assemble a date. In this manner, the client 150 may have control over their experience while relying on the host 110 to provide the necessary planning, scheduling and information. Alternatively or additionally, the selection module 129 may provide the client 150 a menu of prepackaged dates from which the client 150 may select without requiring the client 150 to pick individual elements.

The feedback module 131 includes program instructions that control the host 110 to elicit and/or receive feedback from clients 150. Each client-member 152 may have the ability to provide individual feedback about any specific event or element, which they are provided. This allows the host 110 to better match future dates to the combined preferences of all members of the client 150, as well as to provide better matches for other clients 150.

Turning now to the data storage device 140 illustrated in FIG. 1, this device may be one or more systems, including hardware, software, firmware, or combination thereof that is operable to store and retrieve information, including computer-readable program instructions and data. The data storage device 140 may be, for instance, a semiconductor, a magnetic or an optical-based information storage/retrieval device (e.g., flash memory, hard disk drive, CD-ROM, or flash RAM). Furthermore, the data storage device 140 may store client information in various databases, including a client information database 142, a date inventory database 144 and a date package database 146.

The client information database 142 may include account information, profile information and preference information. Account information is stored in records including login information, client contact information, payment information, and subscription information. Login information may include login names and passwords for each member 152 of a client 150. Contact information may include the names, mailing addresses addresses, telephone numbers, e-mail addresses of the client-members 152. Payment information may include information about one or more accounts including names, providers, identification numbers, password numbers, expiration, credit limits, and the like. The terms of service may include the cost, duration and limitations of the service provided by the host 110.

In some embodiments, the terms of service may describe terms of a subscription to the operator 170's service. The subscription may provide dates to clients 150 on a periodic basis (e.g., once per month, per quarter or per-year) or on an irregular basis (e.g., on-demand, randomly, or in association with the availability of particular types of events). Subscription terms may include, for example, subscription types, identifiers, pricing information, payment information, starting date, and ending date. The subscriptions may be differentiated by features such as duration of the subscription (e.g., three-month, one-year, etc), frequency of the dates (e.g., weekly, monthly, quarterly, etc), payment frequency, which can be separate from the date frequency (e.g., billed monthly but weekly dates), subscription price (also variable per date or per month), preferred date style (e.g., Romantic, Adventure, afternoon, etc).

In addition to subscriptions for regular recurring dates, the system may also provide one-time dates (or prepackaged dates) or dates that occur on an irregular basis. This could include a range of diverse items from special “one-time” opportunities, for example discount tickets to a Broadway show, to subsystems allowing customers to build and purchase elaborate special occasion dates, such as a 20th anniversary getaway to Micronesia.

The profile information may include records describing the clients 150 and the members of the clients 150. The client profile information may include records describing information common to the client-members 152 as a group. For example, anniversaries, observed holidays and children's birthdays.

Furthermore, the client profile information may include schedule preferences. The schedule preferences may indicate that the client 150 desires dates to be scheduled only on every third Thursday of the month. The clients 150 may also indicate specific days, preferred days of the week, and fallback days for dates. Similarly, the schedule preferences could specify times and/or days where no dates are allowed (e.g. major holidays).

Moreover, the client profile information may include a friends list that contains information on individuals with whom a client 150 might like to share date information, or invite to join them on dates. The friend lists may be developed and maintained by the clients 150 themselves using personal information management programs (e.g., OUTLOOK or GMAIL). In addition, new entries may be automatically created when the clients 150 send invitations or date information to individuals not already in the friend list.

The client profile information may also include date records. These records may contain a variety of data for the unique items for the clients 150, for example the seats assigned for a performance, as well as general identifying information for the date elements themselves so additional date details can be retrieved from the date inventory database 144.

In addition to profiles for the client 150 as a group, the profile information may include profiles of the individual members of a client 150 (i.e., “client-member profiles”). These records may describe an individual's demographics, abilities and preferences. Demographics may include, for example, gender, age, race, religion, income, location, occupation, education, hobbies, family size, and the like. Abilities may include, for example, skills, hobbies, exercise habits, and performance levels (e.g., competitive athlete.) The ability information in a client-member's 152 profile may be stored in association with a rating (e.g., a range of 1-10).

Individual client-members 152 may have separate tastes in the types of events and activities that they enjoy. These preferences may include both positive preferences (i.e., those activities which the member prefers) as well as negative preferences (e.g., those activities which the member does not prefer). For example, “likes” and “dislikes” may include type of events, cost of events, density of event, environment of event (hot/cold, wet/dry, crowd level, animals), distance to the event, estimated time to travel to the event, seating, eating, drinking, and the like.

The client information database 142 may maintain preference lists for date elements the client-member 152 has specifically indicated their preference for, as well as preferences that are inferred based on previous date elements the client-member 152 has attended. The preferences can be rated using a variety of systems that assign a rating and/or a weight to the preferences. Different types of preference rating systems could be employed and different rating systems could be used with different preferences. Examples of such systems are: a simple binary like/dislike value; a typical five-value system (strongly like, like, neutral, dislike, strongly dislike); and a numeric range scale (e.g., 1-10). In addition, some or all of the preferences may be related to one another by a hierarchical organization (i.e., a tree structure). For instance, the preferences may include elements that belong to a water-type that may have sub-types, such as swimming events, boating events and waterside events. The relationships between categories may be used to infer preferences about elements in similar categories or sub-categories.

The date inventory database 144 may store records created by the operator 170 that define date elements available for inclusion in dates. The date elements stored in the inventory database may be flagged or removed once they are assigned to a client 150. Any unused date elements in the inventory may be returned to its provider for credit or sold to, for example, a third-party resale sites (e.g., STUBHUB).

The date elements may be rights to attend an event (e.g., a ticket or a reservation), goods and/or services. The different date elements may be categorized as primary elements, ancillary elements or optional elements. Dates are built around primary elements, which are the main event of a date. For instance, primary elements may be tickets to a venue (e.g., theater, sporting event, festival, concert, museum, tour, fair or park). Primary elements may also be services for events that do not require tickets, such as prepaid services or hospitalities (e.g., meals, tours, spas). Furthermore, primary elements may be free events, such as group meet-ups at parks, shops, bars, road trips and the like.

Optional elements are date elements that may be added to a date in association with a primary element. These may include things like meals, transportation (e.g., limousine), gifts (e.g., flowers), greeting cards, upgrades, and side activities. Some optional elements may also be categorized as primary elements. For example, a dinner reservation may be a primary event or optional event that is used in combination with a primary event.

Primary date elements and optional date elements may be stored in association with ancillary elements and element information. The ancillary elements may include, for example, coupons, discounts vouchers, promotional items, brochures, and pamphlets. Element information includes specific facts related the elements, for example the venue addresses, dates/times, menus, costs, etc. This information may be provided as part of the experience such as, directions to the event venue, where to park, appropriate clothing for the event, an explanation, background, history and/or what to expect of the experience, for example rules of polo/divot stomping, icing in hockey, off sides in soccer, translation or explanation of the food menu, and possibly with recommendations of what to order.

The operator 170 may purchase, reserve or schedule events, activities and/or goods from vendors in advance of the event and hold them until they are assigned to a client 150. These date elements may be stored by the date inventory database 144 in association with respective element metadata that describes each element. Element metadata may include, for example, an event name, a description, a location, a vendor, avenue, a face value cost, total cost (including, for example, face value, taxes, surcharges and other fees), an actual cost to the operator 170 (based on, for example, bulk discounts, group discounts, pre-purchase costs, and/or negotiated costs), a description of the event, the time and date of the event, and/or the duration of the event.

The date inventory database 144 record for a date element may be associated with respective preference metadata. The preference metadata includes information that may be used to match a specific elements to client 150 preferences. Example characteristics include: type, sub-types, required skill, skill level, environment, level of danger (both perceived and real) of the location, romanticism, beauty of the location/environment, accessibility, availability of transport, crowd size and crowd type, and reviews.

The date package database 146 may store combinations of date elements that have been allocated to dates (i.e., “date packages”). After a client 150 (or an individual client-member 152) selects a date including one or more primary elements, optional elements and ancillary elements, the host 110 may store a record of the selections in the date package database 146. The operator 170 may review the date packages in the database for quality control purposes (e.g., double-bookings, incorrect locations, incorrect elements, etc.). Additionally or alternatively, the selected elements in the date package may be stored in the client information database 142 in association with the client's 150 account.

The environment illustrated in FIG. 1 is a simplified example having only three clients 150 and one host 110. The disclosed embodiments are not so limited and may include any number of systems that communicate over a variety of communication channels 160 and networks. In addition, some or all of the information illustrated in FIG. 1 as being included in the host 110 may be located apart from the host 110 and accessed over additional communication channels 160. For example, in some embodiments, the environment may include a number of host 110s that service different geographic regions, some or all of which share information with one another and/or a central controller.

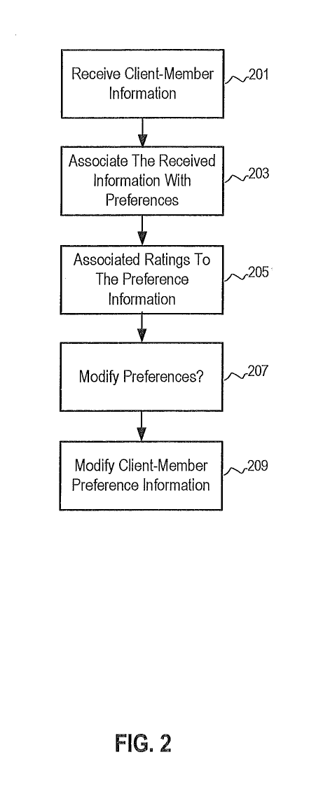

FIG. 2 illustrates an exemplary method for inferring client-member preferences. The preference inference module 125 may receive information regarding a client-member 152 from several sources, including the client information database 142, the client profile module 123, the selection module 129, the feedback module 131 and third-party providers of demographic and business intelligence information. (Step 201) The received information may be associated with a descriptor of the information and a corresponding rating.

Based on the descriptors, the received information may be associated with one or more preference types. (Step 203) In some instances, such as when the information is generated by the host 110, the descriptors may correspond to predetermined preference types associated with the information. In other instances, such as when the client-member 152 information is provided by a third party provider, the preference inference module 125 determines types of preference information that the descriptor information should be associated with. This determination may be performed automatically by the feedback module 131 (e.g., based on a predetermined dictionary of terms), manually by the operator 170, or a combination of both.

The received rating information is stored in association with the corresponding preference types. (Step 205) In some cases, such as when the preference information is received from a third party provider, the feedback module 131 may extract the rating from the received client-member 152 information and normalize the rating information to be consistent with the host 110's rating method for the selected preference type.

Based on the rating information, the preference module may determine whether to change corresponding preferences in the client-member's profile. (Step 207) In some instances, the preference module may modify the profile whenever a corresponding rating is received. (Step 209) In other instances, the preference module may only change the profile after some threshold is exceeded by a combination of corresponding rating information received over a period of time. Furthermore, although not shown in FIG. 2, the client-member 152 may be given an option by the host 110 to manually modify and eliminate preferences in their profile.

The preference inference module 125 may further use comparisons of preferences and feedback from client 150 accounts which have similar profiles. Thus, for example, if two accounts indicate similar preferences and one of the accounts has reported very high satisfaction with a particular event, then there is a high likelihood that that second account would also enjoy this activity.

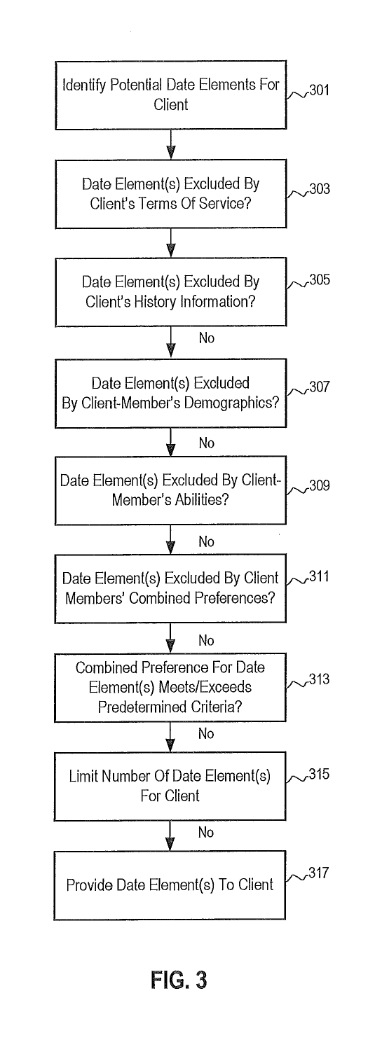

FIG. 3 illustrates an exemplary method for matching date elements with clients 150. The date matching module 127 may identify one or more date elements to be provided to a client 150. (Step 301) For example, the matching module 127 may identify primary date elements stored in the date inventory database 144 that are within a certain time frame (e.g., a two week window). The time frame may be determined based on an ad hoc client request (e.g., a request for a date for a particular week) or reoccurring basis (e.g., a monthly subscription).

The matching module 127 may determine whether any of the identified date elements are excluded by the client's 150 terms of service. (Step 303) For instance, an identified date element may be rejected if it occurs outside the client's 150 period of subscription, if it exceeds a cash value the client 150 is allotted to spend, or their type of subscription (e.g., adventure or romance). In addition, the matching module 127 may determine whether any of the identified date elements are excluded by the client's 150 history information. (Step 305) For instance, an identified date element may be rejected if the client 150 has recently accepted and/or attended the same or a similar type of date element. The matching module 127 may also determine whether any of the identified date elements are excluded by the client-members' 152 demographics. (Step 307) For example, a pork-festival may be rejected based on a client-member's 152 religion in his/her demographic information. Additionally, the matching module 127 may determine whether any of the identified date elements are excluded based on the client-members' 152 abilities. (Step 309) For instance, an advanced-level ski trip may be rejected if a client-member 152 has indicated that they are a novice skier.

The identified date elements are compared with the client preference data and selected based on the comparisons. The comparison may be made based on metadata associated with the identified elements. The matching module 127 may determine whether any of the identified date elements are excluded based on the client 150 preference information. The determination may be made based on both the client preferences and the individual client-member preferences. The client preferences may exclude some or all of the identified elements based on conflicts in the client's 150 schedule or other such limitations.

The matching module 127 may also determine whether any of the identified date elements are excluded based on combinations of the individual client-member preferences. (Step 311) In some embodiments, an identified date element may be excluded if it conflicts with the preferences of one of client-members 152. In other embodiments, the matching module 127 may compare metadata of the identified events with a combined preference rating determined for some or all of the members of a client 150.

For instance, where the client 150 is a married couple, the husband may hate opera and, as such, his preferences may rate opera events as a “1” on a scale of one-to-ten. In comparison, the wife may enjoy the opera and rate it as a “7” in her preferences. Based on these ratings the matching module 127 may determine a combined preference score. In one example, the matching module 127 may average the two preferences together to obtain a combined preference of “4” for the opera event. This value may be below a required threshold criteria of, for example, “6” and thus be excluded. On the other hand, the husband may dislike the opera and the wife may absolutely love it, such that their preferences rank opera events as “4” and “10,” respectively. In such instance, the combined preference may be a “7,” which would exceed a threshold criteria of a combined “6” rating. (Step 313) Accordingly, the matching module 127 may determine that the opera element may be offered to the couple. Of course, the matching module 127 may use more complex algorithms that may rely on combinations of different preferences and metadata to determine a combined preference for the clients-members 152.

The matching module may limit the number of date elements that are provided to the client 150. (Step 315) The number of date elements provided may be limited based on the client's 150 profile information. For instance, the terms of service may specify that the client is offered four dates per month of which the client must choose one. In another instance, the client's 150 subscription may provide that the client is automatically scheduled for one date per month without any choice. Furthermore, the client's 150 preferences may indicate that the client would like to be offered three dates at a time for their acceptance.

The matching module 127 may provide the date elements that are not excluded by the client profile information or the client-members' 152 preference information to the client. (Step 317) Based on the provided date elements, other date elements and information may be offered, assigned and/or provided to the client.

In another embodiment, rather than having the client 150 select individual elements, the matching module 127 may offer prepackaged dates from which the clients 150 can choose the specific date they would like to go on. In this case, each option could represent a full date package. These date elements may be presented such that the client-members 152 must choose one from the list.

The matching module 127 may treat some events differently. For example, touring Broadway shows are very popular and tend to have a relatively wide range of available show dates. But yet the total number of tickets available may be very limited. Thus, the matching module 127 may assign these limited numbers of seats before any other matching algorithms are employed. In this instance, the accounts might be sorted in a preference order based on length of time in the club, VIP status, or preference for Broadway shows. Then, if one were using length of time, one could say that the most loyal customers (e.g. those having been in the club the longest) would be assigned seats first. Alternatively, the matching module 127 could assign the newest customers seats as a goodwill gesture to ensure that new customers immediately have an excellent experience within the club.

In some embodiments, the matching module 127 may allow for operator input, for instance, when the matching module 127 is unable to make a choice. The matching module 127 may create a list of recommendations for each client 150 and then have the operator 170 select from the recommendation list, or even completely override the recommendations for the match. This subsystem could allow the operator 170 to review the client-member's preferences, inferred preferences, the feedback history, and/or other similar account's feedback for the potential events, as well as all of the details of the potential events including general satisfaction levels with accounts and those events. Such intervention by the operator 170 might also occur when a new event is introduced to the date inventory database 144, the new event might be assigned by a human operator to specific accounts until there is sufficient history with account feedback on the activity to allow the matching module 127 to effectively evaluate its suitability.

The host 110 may assist in the matching process by sending the clients 150 a series of questions, (e.g., on a user interface, an email query, or survey tool) prior to making a date selection. The client's 150 responses could be used to help influence the actual choices provided. In this way the system could continually enhance its knowledge of the client-member's 152 preferences.

The steps performed by the matching module 127 to match dates with clients 150, as illustrated in FIG. 3 and disclosed above, are described as a process of elimination for the sake of explanation. Of course, other methods of matching date with clients may be used. For example, the matching module 127 may use matching process that identifies date elements from sets (and subsets) based on the elements' correspondence with a client's 150 preference information. Such a matching process may reduce the amount of information processing required by the host 110 to identify date elements for a client 150 by allowing the matching module 127 to search only part of the date inventory database 144 until a sufficient number of matching elements are identified.

Furthermore, while FIG. 3 illustrates a series of steps 301-317, embodiments consistent with disclosure are not so limited. The steps 301-317 may occur in different order, some of steps 301-317 may be excluded and/or additional steps may in included.

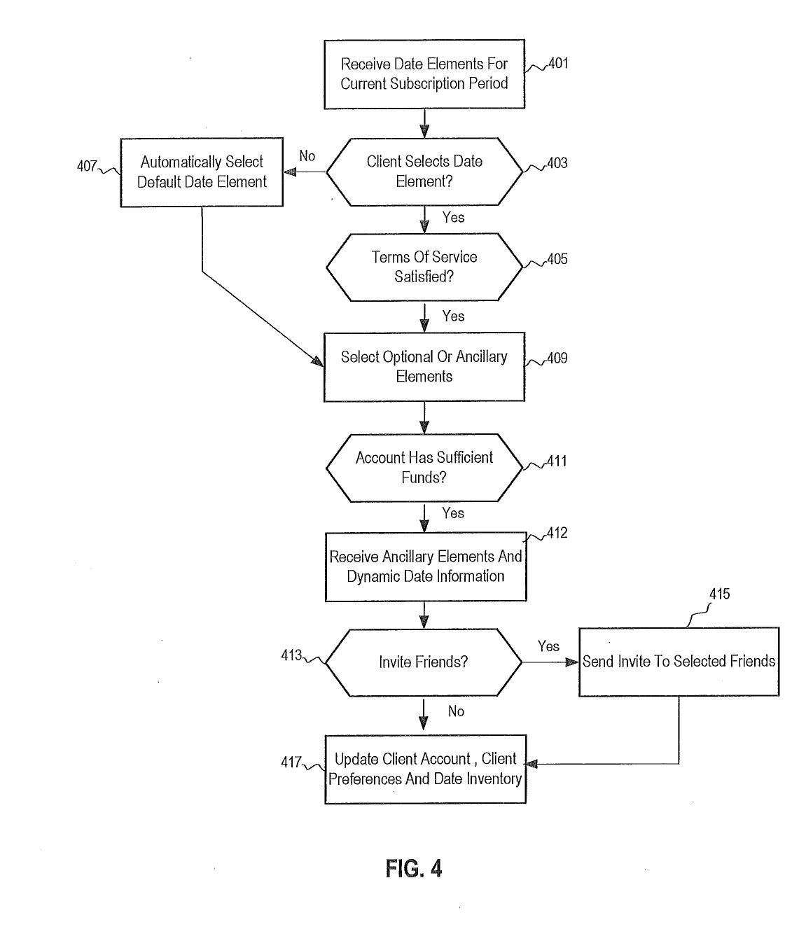

FIG. 4 illustrates an exemplary method for selecting a date for a client 150. The client 150 may receive one or more date elements from the host 110. (Step 401) The received dates may occur to a particular day that corresponds to a specific event. Alternatively, the provided dates may occur within a window of time (e.g., weekly, monthly, and yearly) during which dates may occur. The timing of the provided dates may correspond to the terms of a client's 150 subscription (dates per year, cost, type, etc.) or preference information.

Notably, the host 110 may provide the date elements in association with schedule information associated with the client's 150 account. For instance, the information may be presented as a calendar containing details of upcoming dates that have been assigned or offered to the account, as well as a historical record of the dates that have already passed. The schedules may also include prospective date elements which the clients 150 may be interested in attending but which are not provided to the account under their subscription.

In some embodiments, the client 150 may only receive a single date element (or prepackaged date) from the host 110. If so, the client may be given the option to accept the host's 110 offer or reject it. In other cases, the host 150 may not give the client any choice to reject the date. That is, the client 150 may simply be informed that they are scheduled for specific date.

In other embodiments, the client 150 may be provided a set of primary date elements to choose from. In such instances, the client 150 may be informed by the host 110 that a particular date element is the default if none is selected within a specific time period. For instance, the client 150 might be told that the host 110 will randomly select one of the elements if the client 150 does not indicate a preference within a week. Additionally, the dates received by the client 150 may have limited availability and the client 150 may find that one of their choices is no longer available if they waited too long before selecting it. If so, the client 150 may be notified that the date choice in question has limited availability, and perhaps also the number of available slots remaining. Furthermore, when choosing from the set of choices the client 150 may be interested in more than one choice. Since they can only choose one for their next date, an embodiment could allow the member to rank the choices in terms of preference, or desirability. By doing so the system can store this information, and for dates that were not chosen, but of interest, could then make those dates available again later.

The client's 150 selection of a date element may be affected by the element's value. That is, when the client 150 receives a date element from the host 110, the information presented might include the element's associated total value. The total value may represent the full cost a client 150 would pay for the element (including face value, taxes, surcharges and fees), as opposed to the actual cost that might be paid by the operator 170 to a vendor (including discounts for advanced or bulk purchases). When an element is selected, that total value could be subtracted from an available balance for future dates from the service. Thus, for example, an account with a twelve-month subscription at $100/month may have a starting remaining balance of $1200. If the client-member 152 selects an initial date from the option list with a total price of $200, then the client 150 would have $1000 in subscription value remaining for the next 11 months.

When the client 150 selects a date element or a prepackaged date or, alternatively, when a date element or prepackaged date is assigned to the client 150, the selection module 129 may send information to update other modules and databases of the host 110. (Step 403) For instance, the client profile module 123 and/or the preference inference module 125 may update the client's 150 schedule and the preference information. In addition, the selection module 129 may update the date inventory database 144 to indicate that the date element has been accepted and, therefore, are unavailable to other clients 150.

After the selection or assignment of a primary element, the selection module 129 may, via the user terminal 150, offer the client 150 optional elements for inclusion in the date. (Step 405) Examples of optional elements may be up-sells such as, adding limousine transportation, flower delivery, babysitting services, or pre-paid parking to an existing date. The selection module 129 may include the ability for the client 150 to accept these up-sells including via user interfaces (e.g., buttons on the web pages or email pages) at a user terminal 154. These select buttons may take the client 150 to a confirmation page from which the charges are automatically made to the existing payment vehicle on their account, or from which alternate payment arrangements may be made, including direct payment to a provider or a vendor.

The host 110 may provide ancillary elements and information associated with the selected date elements. (Step 412) Additionally, the selection module 129 may also generate dynamic date information based on the client's 150 selected elements. The dynamic information may be, for example, directions from the client's 150 home or current location, a weather forecast and associated clothing suggestions; reservation confirmations, ticket receipts and the like.

In many cases, clients 150 may enjoy experiencing activities with other couples. As a result, the host 110 may allow client-members 152 to coordinate with others on dates. One example of this is to include a selection in the client's 150 user interface (e.g., a web page) where they can invite friends, who may or may not already be members of the service, to join them on an already scheduled date. (Step 413) This button could then allow the client 150 to input the contact information for the friends (email, phone, address, etc) such that the host 110 can send an invitation to the friend to join the member on the specific date. (Step 415) In addition to the contact information, the client 150 could indicate whether they are willing to sponsor the friend (e.g. the member will pay for the date for the friends), or that the friends would need to pay directly. The client 150 can indicate one friend or a series of friends to join them.

Once an invitation is extended, the friend's contact information may be stored in the database as a prospective invited date, as well as a prospective customer for operator's services. One method of contacting the invitee may be email, which could include a link that allows the invitee to accept the invitation and provide additional information about the date such as the event location, reviews, date/time, accessibility, etc. In addition, the system could keep records of friends that have been previously invited and provide an automatic mechanism, for example through a drop down box when entering the friends to invite, which automatically allows easy selection of previously invited friends.

In some instances, two or more clients 150 might like to have a common series of dates. The system may support this by allowing client-members 152 to include an affinity with other clients 150 on different accounts. In this way, during the date selection process, clients 150 with an affinity may be treated as a single client 150. If treated together, the preferences of all members of the accounts in an affinity group may be taken into account by the matching module 127. The system may allow the degree of affinity to be described. For example, a system with two levels of affinity might be “like to include” and “must include.” In this system, if the affinity is “must include” and one of the accounts in the group has a vacation hold the date would be scheduled later for all accounts in the group. However if the affinity is “Like to include,” then the account with a vacation hold might be scheduled to a separate date than the other accounts in the affinity group.

The selection module 129 may allow clients 150 to indicate an interest in meeting other, new, couples. Clients 150 who have indicated such an interest could be made aware that other couples will be attending the same event and be provided relevant contact information (either direct email, or indirectly through the host 110). In another example, the system could use the preferences from each subscriber set to match couples that might be compatible and then set them up on a specific double date. This could be done as a “blind” date where they do not know each other until the actual date occurs, or the couples could be introduced via email, etc prior to the actual date.

In addition, client's may be able to indicate a preference to meet new couples, or join a regular “date group.” These date groups may be associations where the members are assigned the same events so that they get a chance to meet one another. In addition, for date group events, dates may be selected that include a group element that provides the clients 150 in the group an opportunity to meet and socialize. For example, the special group element might be a short reception and discussion with the playwright of the play for which the members of the group have tickets. Alternatively, the primary might be specially structured for only the group. For example, the date package might revolve around a river dinner cruise where the entire boat is chartered solely for members in one or more date groups.

Occasionally, a client 150 will be unable to take part in an already scheduled date. In order to support changes, the selection module 129 may allow clients 150 to make changes to a selected date. One function may allow the members to request changes to the date. These changes might include providing a different time/date for what would otherwise be the same event; requesting a completely different event, for example where one member of the account specifically does not want to attend the assigned event; requesting a postponement of the date, for example due to illness, etc. The host 110, in some cases, may automatically allow the requested changes. For example, in the case of a date whose primary element is a restaurant dinner at a restaurant making changes to the event is usually easy and allowed up until the last minute. In other cases, changes may not be allowed or must be manually reviewed. For example, if the primary element is a Broadway show, changes may be difficult, if not impossible, to effect. In some embodiments, the date information could include information for the members highlighting change policies for that particular date.

As noted above, rather than having to pick individual date elements, the client 150 could also be offered a set of prepackaged dates. In some embodiments, the prepackaged dates may be a series that are predefined for a subscription. For example a Romance-themed subscription could be created that would have a set of twelve predefined dates packages that could be reviewed prior to selection.

In some embodiments, the selection module 129 allows clients 150 to create and organize special dates. For example, one member might like to create a special “anniversary” date. The special events could range from a one-time “VIP” seating at a sports event to a Limo pickup for a normal date, to a custom trip to Paris with all details provided by the service. The member may be able to indicate that this event is to be kept private (e.g., it is a surprise). In this case all details about the date will be hidden from other client-members 152, and may be delivered directly to the member who organized the date. After the date, the system may allow this event information to then be visible in the joint date history of the account.

In the case where the client 150 is a large group, selection module 129 could enable clients 150 in the group to select from the choices. For example, any member in the group could make the selection for the group, essentially first come first served. Or, once a majority of the members select one of the options, then it becomes the selected event. Also each member could provide a priority ranking and the choice with the highest ranking would then become the group choice.

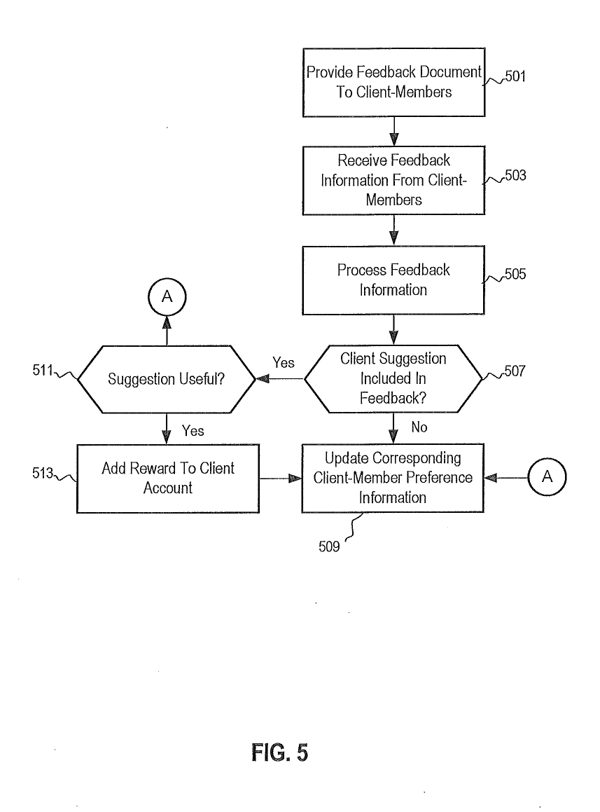

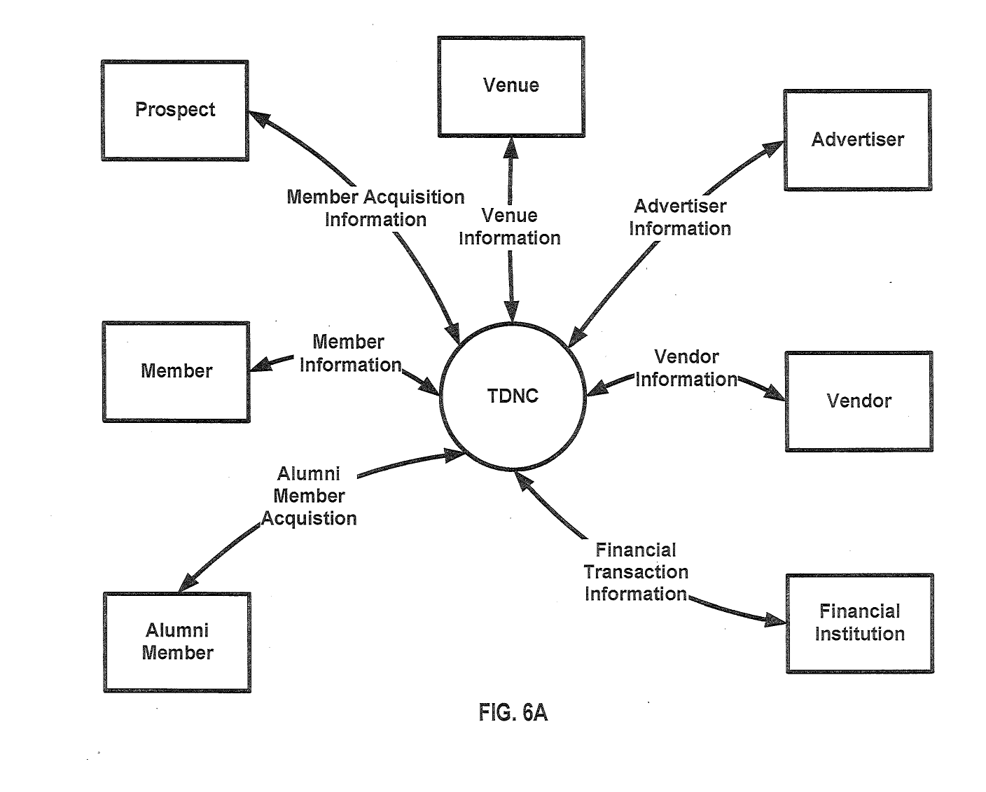

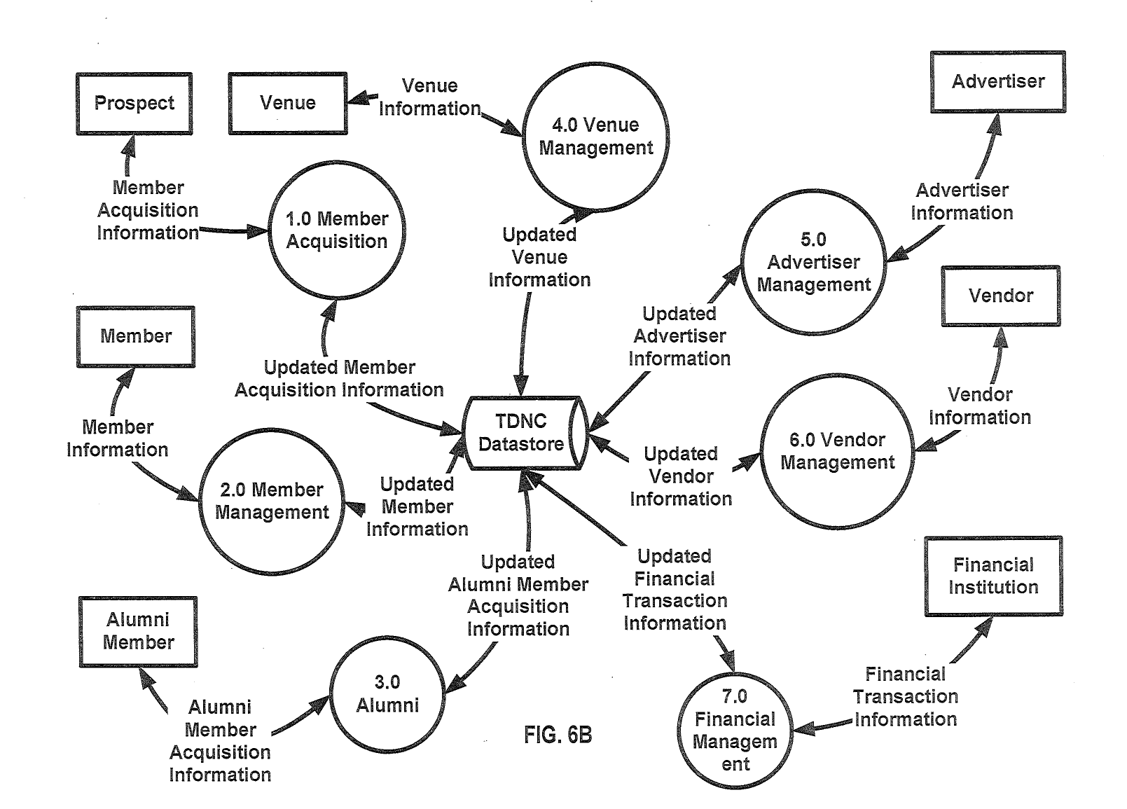

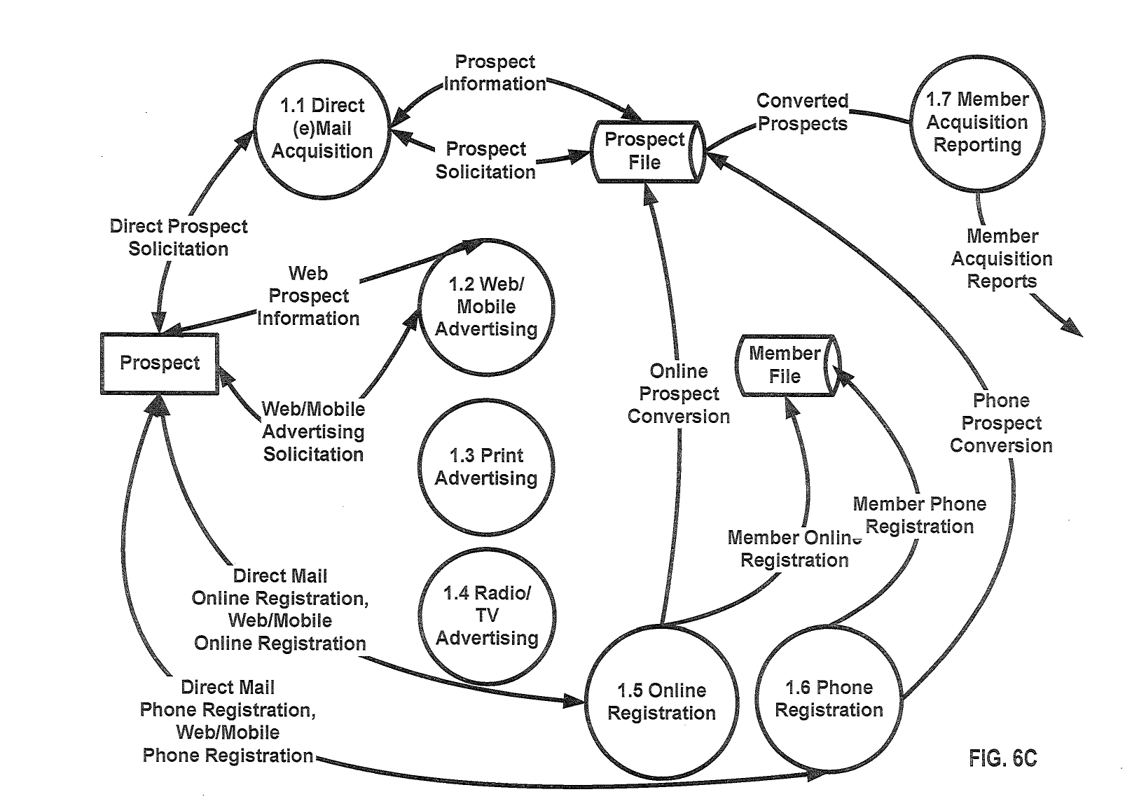

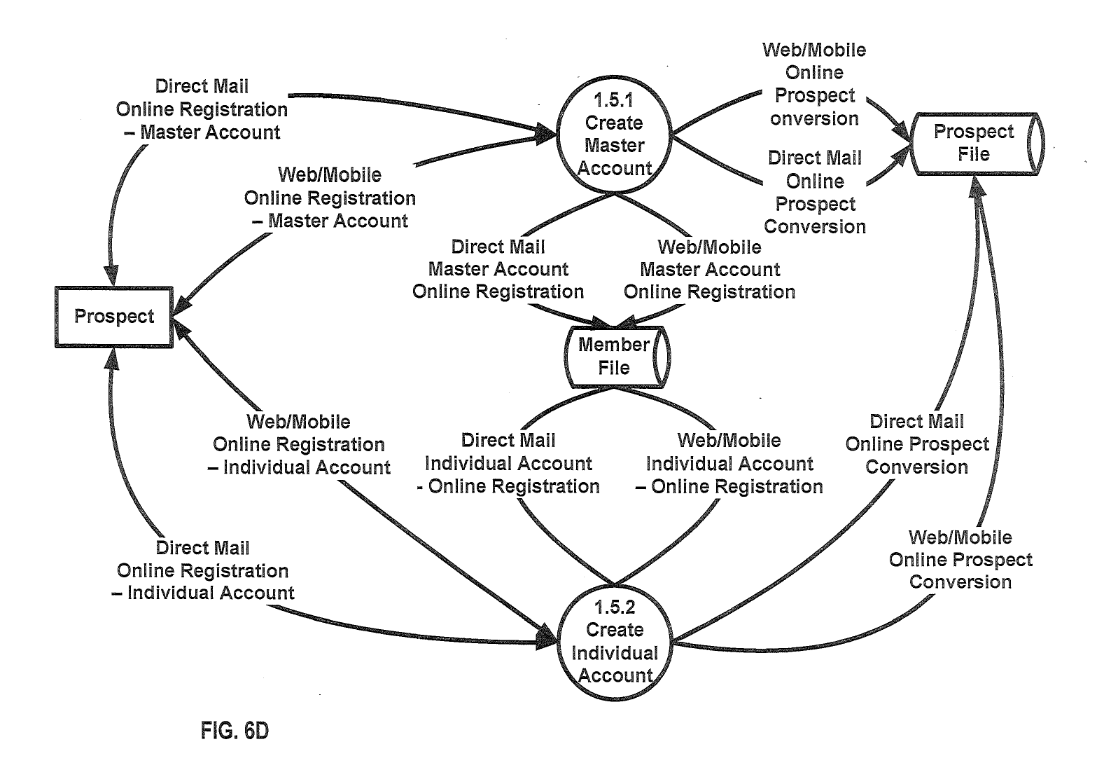

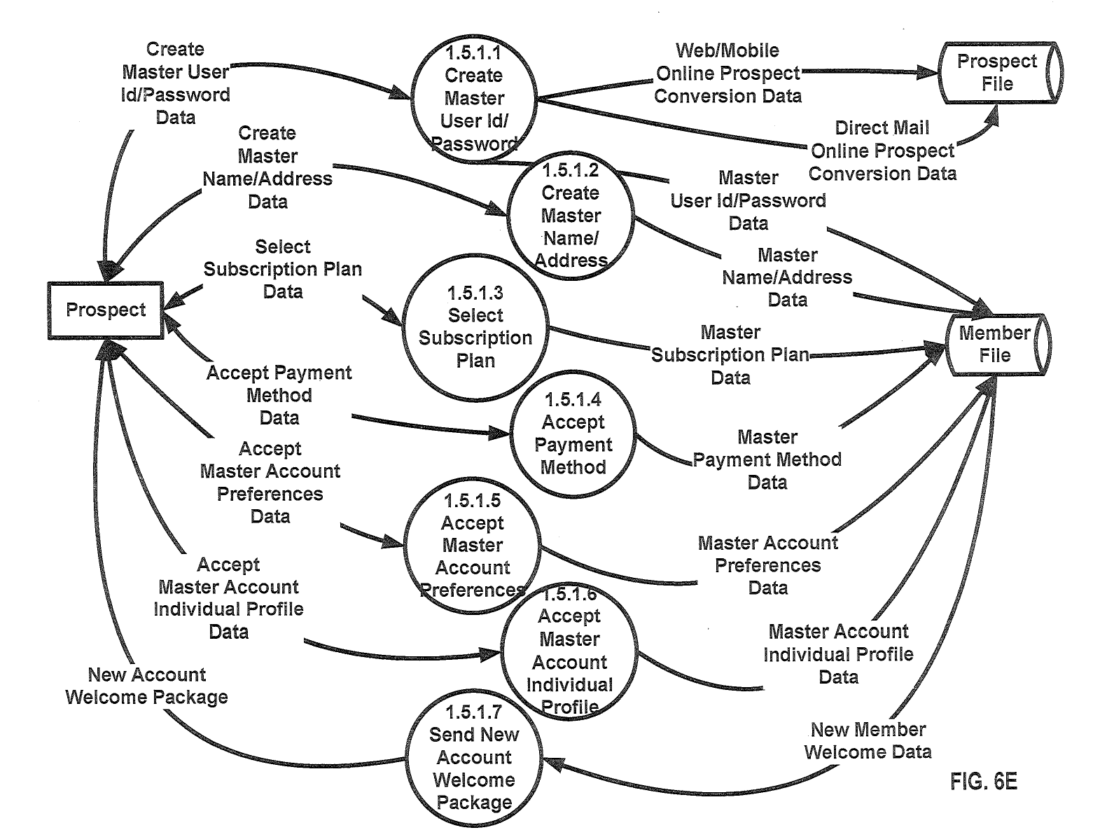

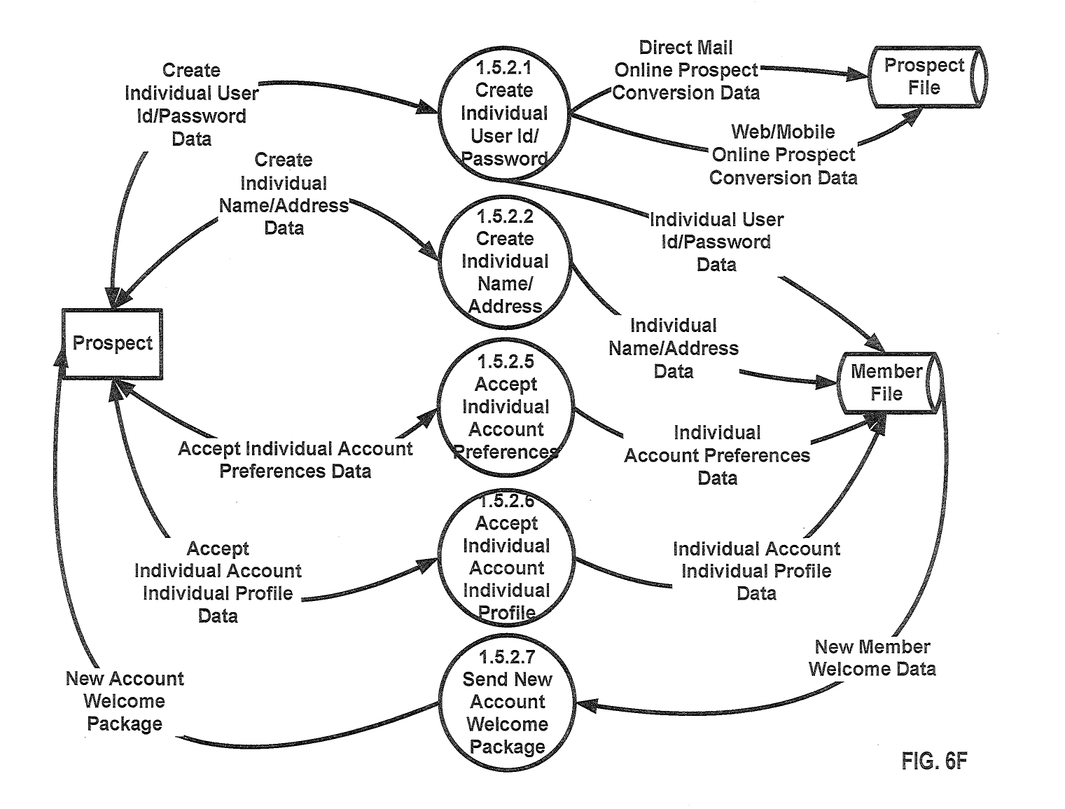

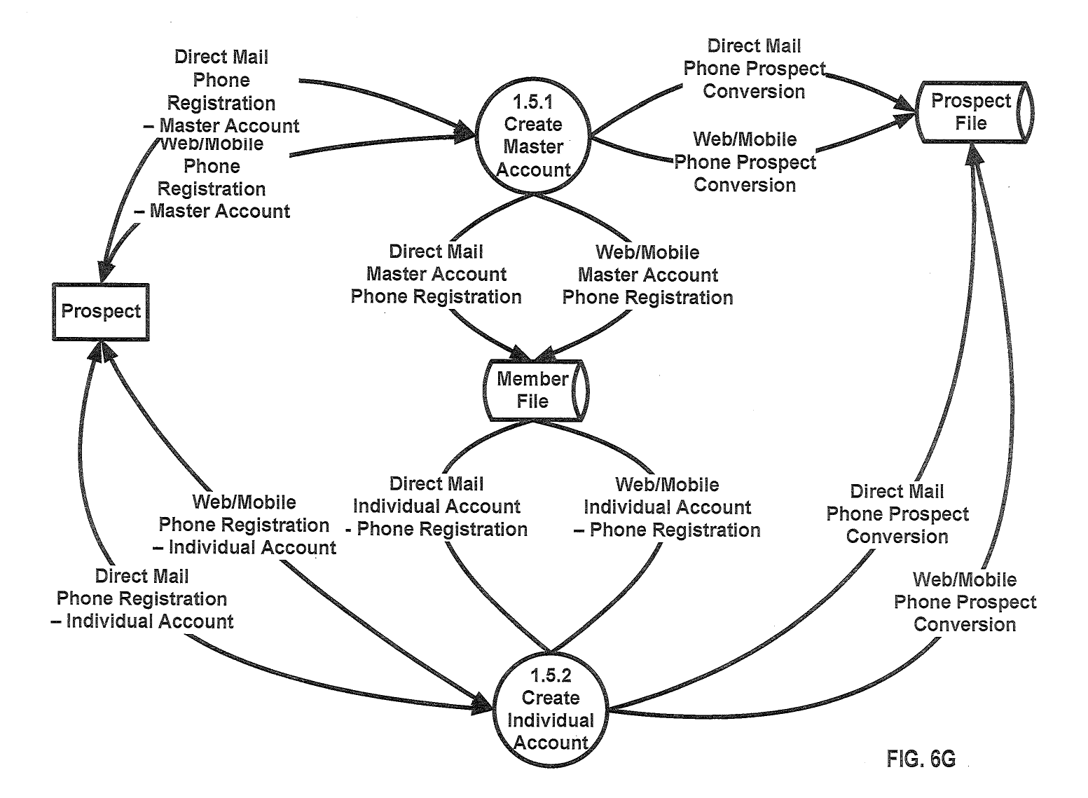

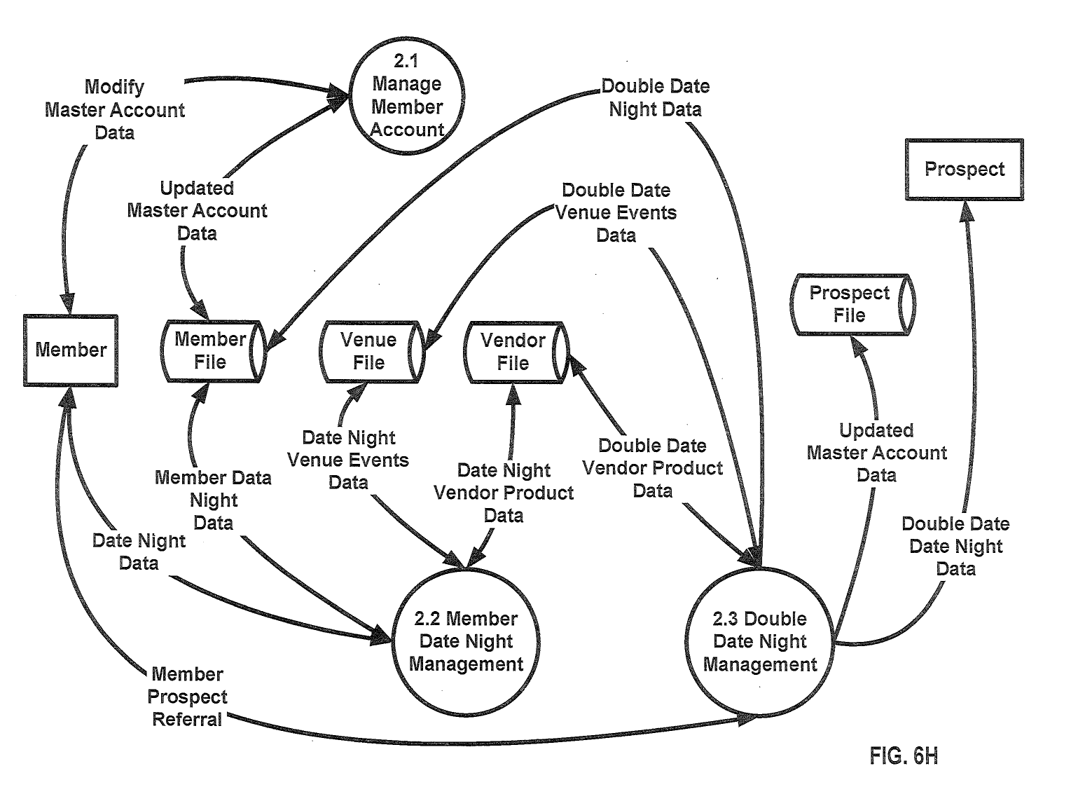

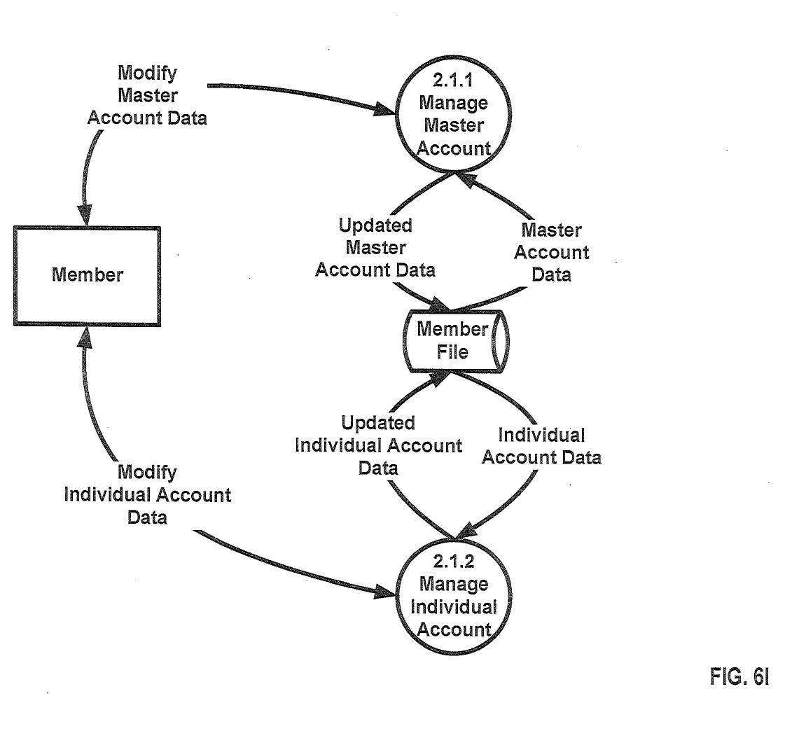

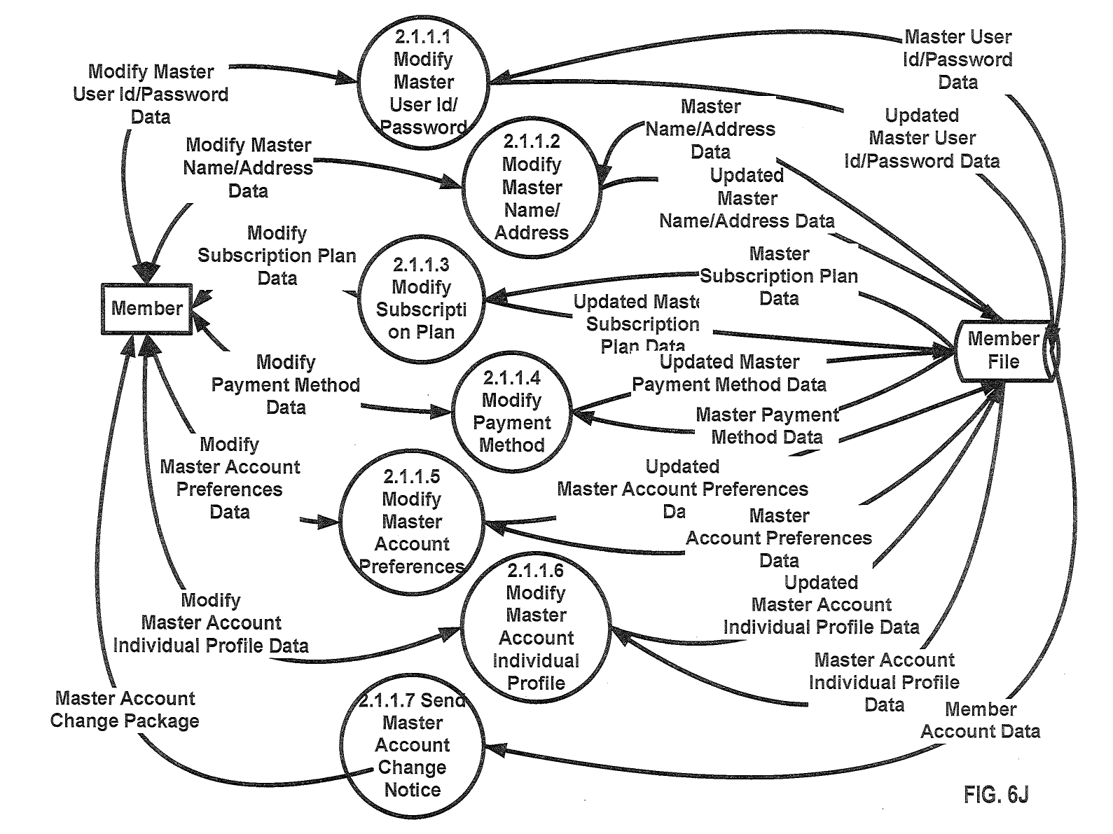

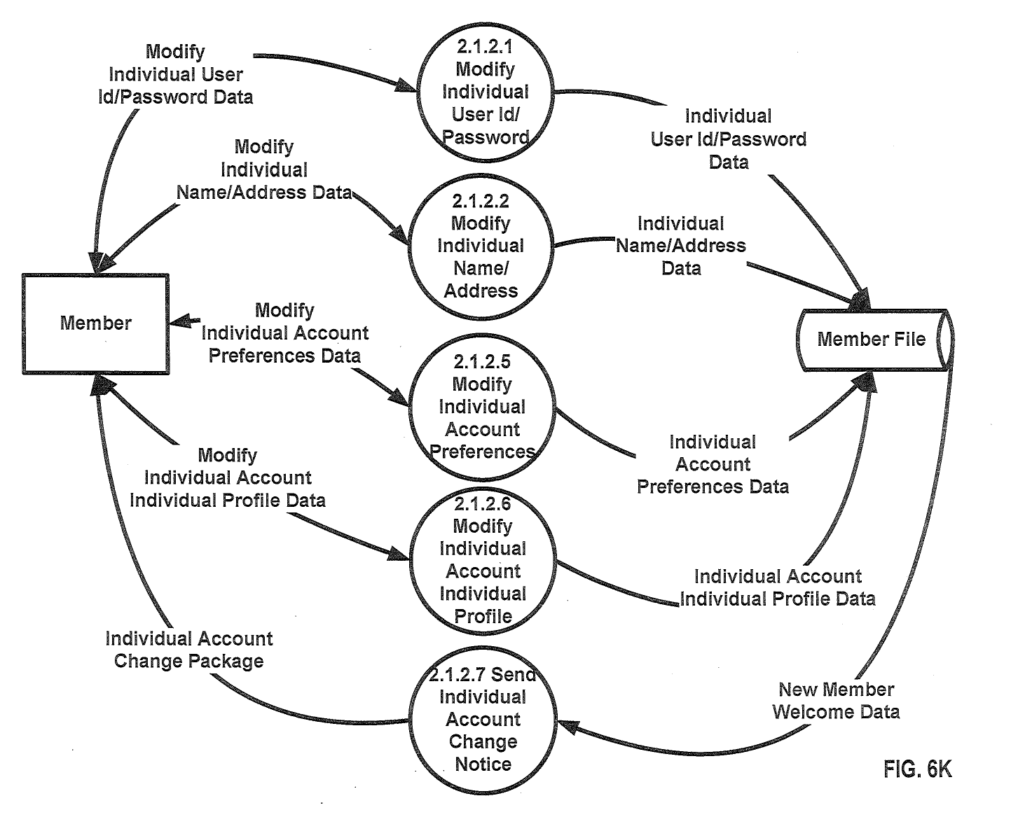

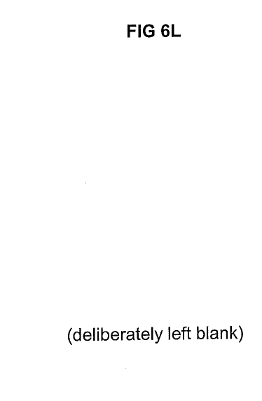

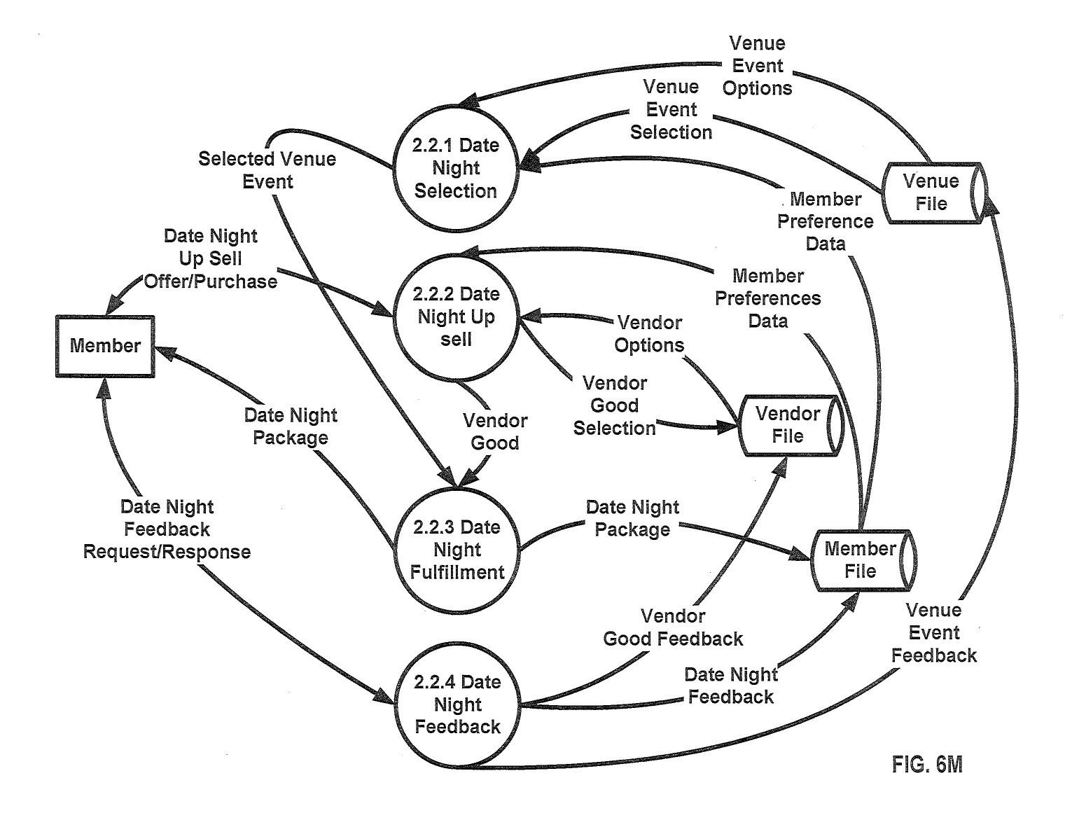

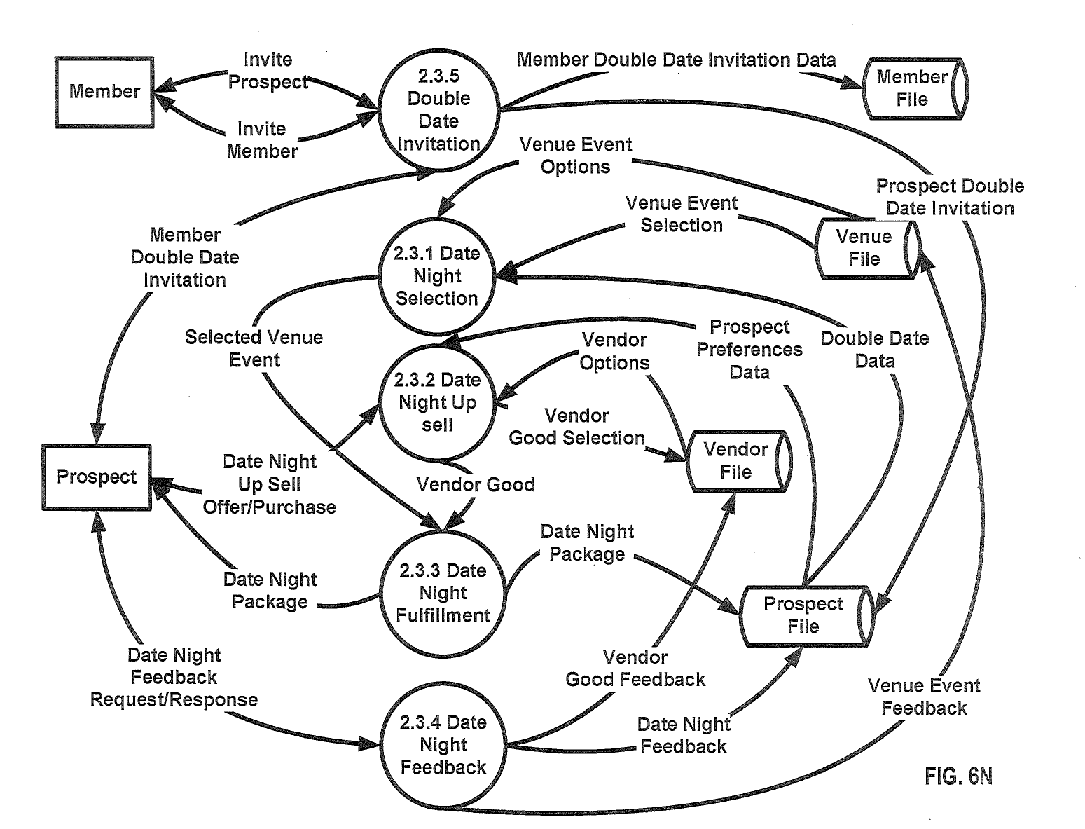

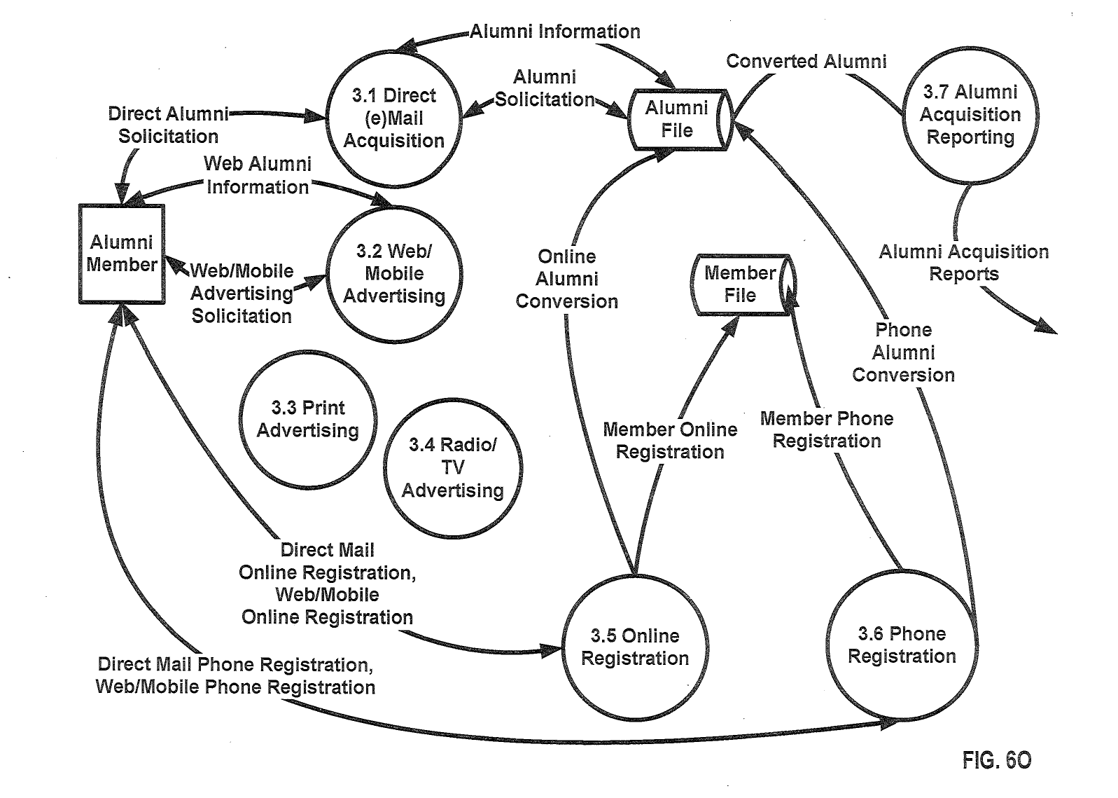

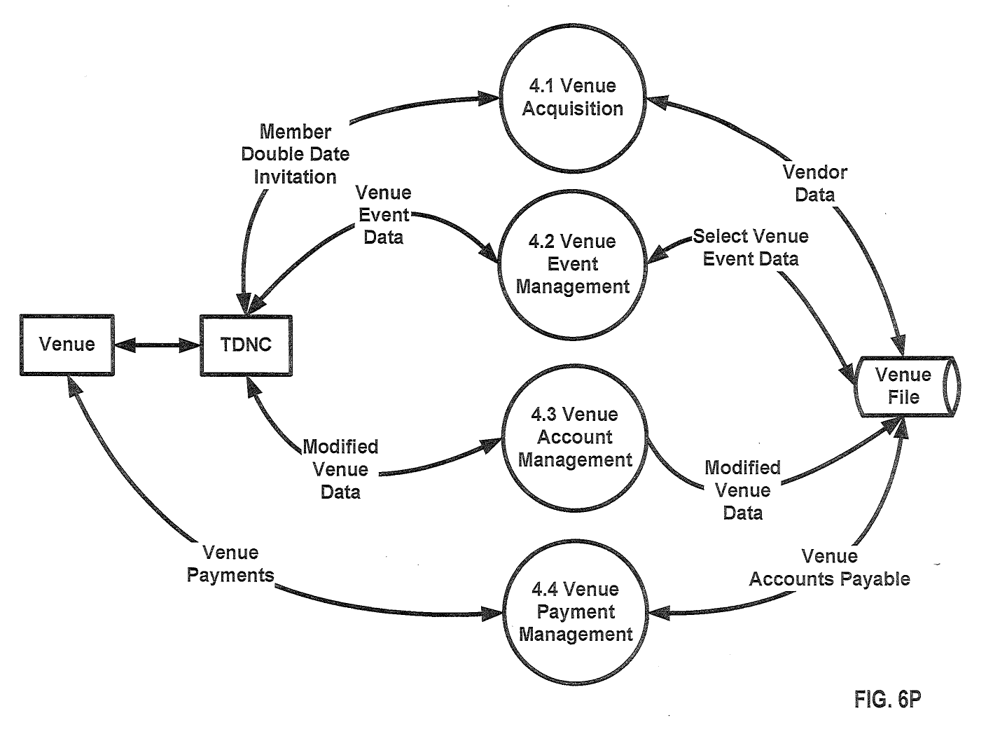

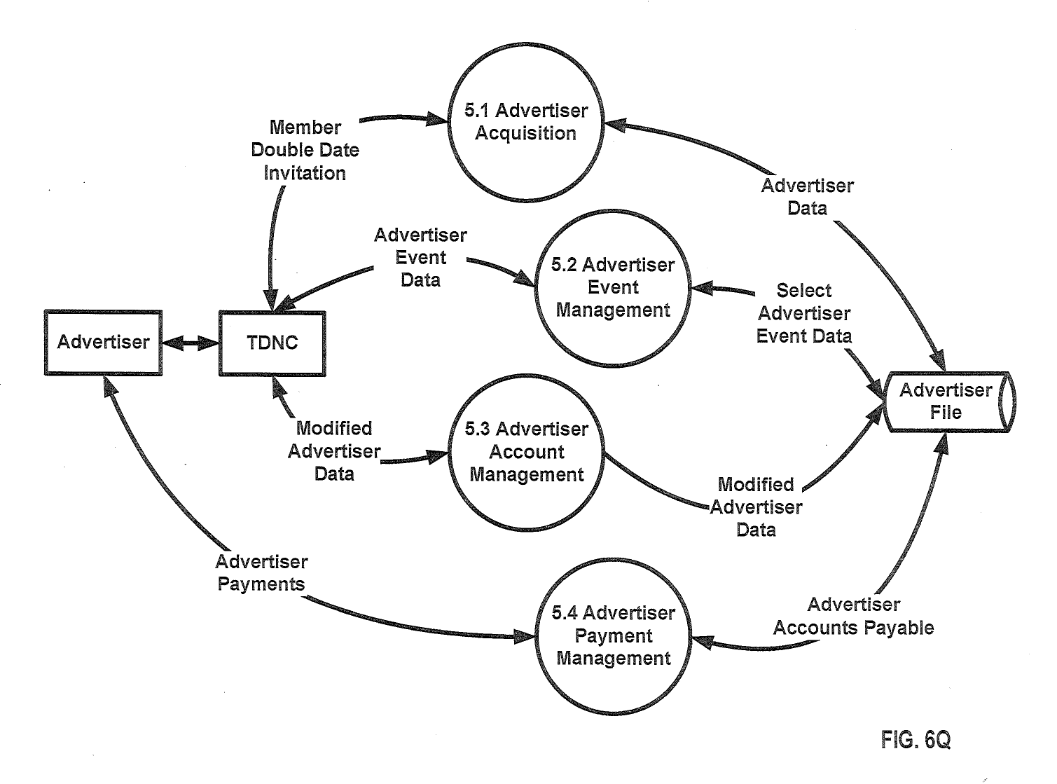

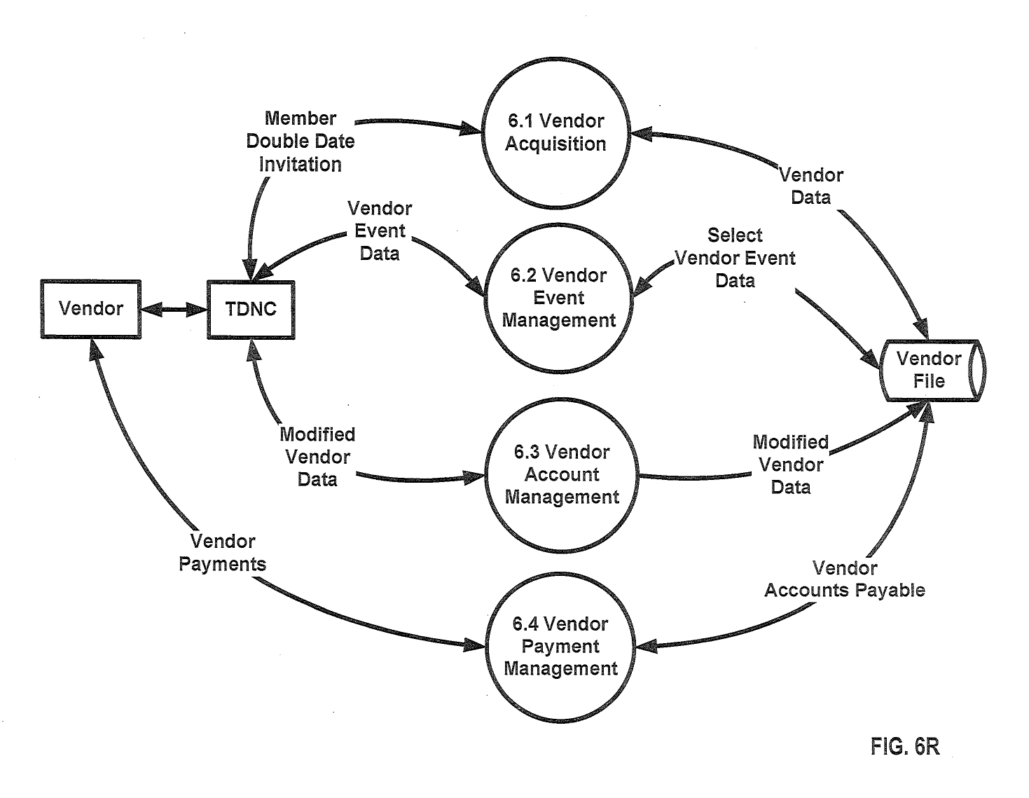

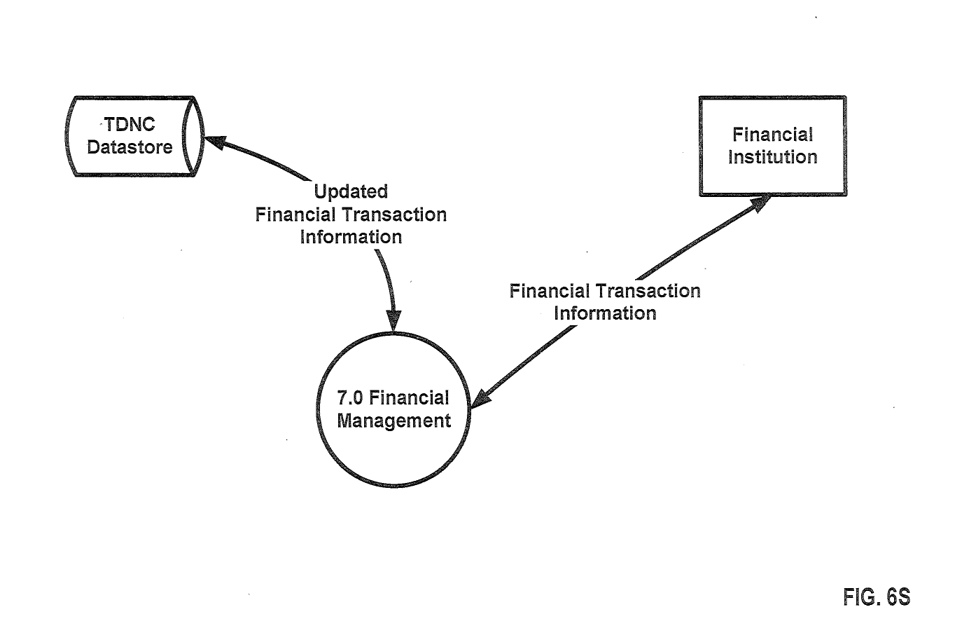

FIG. 5 illustrates an exemplary method for receiving client 150 feedback on a past date. Via the user terminal 150s, the date feedback module 131 may provide documents to the clients 150 allowing them to provide feedback about a date they participated in. (Step 501) The feedback documents may be provided in a webpage, an email, an online survey tool, a paper document, or verbally by telephone. The feedback document may be freeform and/or include a number of predefined questions.

The host 110 may receive feedback from each client member 152 about a date. (Step 503) Client-members 152 can manage and report their feedback separately or not report any feedback at all. For instance, after a family takes a historic walking tour, one child might want to report that they hated it, while the other family members might report that they enjoyed it.

The host 110 may process the received feedback information. (Step 505) For instance, the feedback reports may be used by the feedback module 131 to update preferences in the respective client profile or client-member profile. The matching module 127 may then take into account these preferences of the different client-members 152 when selecting elements for future dates. Furthermore, in some embodiments, the feedback information may be inferred from the client's 150 choices made in selecting a date. For instance, the feedback module 131 may receive information from the date selection module 129 regarding the date elements a client 150 was offered and the elements the client 150 selected and/or did not select. Based on the client's 150 choices (e.g., failure to select a theater event) and/or the client's 150 choices over time (e.g., never selecting a cultural even), the feedback module 131 may store this information for reference by the preference inference module 125.

Additionally, the feedback module 131 may include a mechanism by which the operator 170 can review freeform comments and then adjust the client-members 152 implied preferences based on the freeform feedback. For example a client-member 152 might report that they did not feel safe at a particular venue. Based on this feedback an operator might adjust an implied preference for “edgy” venues to dislike, or might flag the account for manual matching when an event might be at the venue in question.

In some embodiments, the feedback module 131 may allow clients 150 (or potential clients 150) to suggest date elements. (Step 507) This could include the primary element, such as a new restaurant or event, or could include ancillary or optional elements such as information packets, or picnic lunches. To encourage such submissions, the feedback module 131 might include a reward mechanism for clients 150 whose recommendations are accepted, or a random drawing type of reward mechanism for all suggestions. In the event a client 150 suggestion is included in the feedback information, a determination is made whether the suggestion was beneficial (step 511) and, if so, the feedback module 131 may add a reward to the client's 150 account (step 513).

The preference information of client-member 152 may then be updated based on the received feedback, (Step 509) As described above, the modifications to the preferences may be based on a correlation between an element and a preference. In some embodiments, the system may support making the feedback from dates available to other members, or even the general public, for them to use when evaluating specific options for dates they may want to make themselves.

As disclosed herein, embodiments and features can be implemented through computer hardware and/or software. Such embodiments can be implemented in various environments, such as networked and computing-based environments with one or more users. The disclosed embodiments, however, are not limited to such examples, and the embodiments can be implemented with other platforms and in other environments.

Other embodiments of the invention will be apparent to those skilled in the art from consideration of the specification and practice of the embodiments of the invention disclosed herein. Further, the steps of the disclosed methods can be modified in any manner, including by reordering steps and/or inserting or deleting steps, without departing from the principles of the invention. It is therefore intended that the specification and embodiments be considered as exemplary only.

What is claimed is:

1. A computer-implemented method for providing a date event to a client, said client including two or more members, said method comprising:
identifying one or more date elements for the client;
determining whether one or more of the identified date elements are excluded based on client profile information;
determining whether one or more of the identified date elements are excluded based on respective profile information of two or more of the members; and
providing to the client the identified date elements that are not excluded by the client profile information or the profile information of the two or more of the members.

2. The method of claim 1, wherein providing the identified date elements comprises, selecting a predetermined number of said identified date elements to be provided to the client.

3. The method of claim 2, wherein the number of said identified date elements to be provided to the client is determined based on client profile information.

4. The method of claim 1, comprising, providing additional date elements to the client that are associated with at least one of the provided date elements.

5. The method of claim 1, comprising, scheduling a date event for the client, said date event including at least one of the identified date elements provided to the client.

6. The method of claim 1, wherein at least some of the date elements include one or more of the following: activities, goods and/or services.

7. The method of claim 6, wherein, the activities include one or more of the following: social events, entertainment events, shows, sporting events, cultural events, festivals, parties, meals, meetings, and trips.

8. The method of claim 1, wherein, the client profile information includes one of more of the following: terms of service information, subscription information, preference information and history information.

9. The method of claim 1, wherein, the profile information of the members includes one of more of the following: demographic information, ability information, and preference information.

10. The method of claim 1, wherein the preference information is inferred from the demographic information, ability information, event selection information, and feedback information.

11. The method of claim 1, wherein said determining whether one or more of the identified date elements are excluded from the offer based on respective profile information of two or more of the members includes combining preference rankings of said members.

12. The method of claim 1, wherein providing to the client the identified date elements includes, automatically scheduling one of the identified date elements for the client.

13. The method of claim 12, wherein the automatically scheduled date element is designated as a default element.

14. The method of claim 12, wherein the automatically scheduled date element is randomly selected from the identified date elements.

15. A system comprising a processor and a memory device, said memory device storing program instructions that, when executed by the processor, control the system to perform the functions recited in claims 1-14.

16. A non-transient computer-readable medium having program instructions stored thereon that, when executed by a processor, control the system to perform the functions recited in claims 1-14.
